(19) United States
(12) Patent Application Publication
(10) Pub. No.: US 2026/0051179 A1
(43) Pub. Date: Feb. 19, 2026

(54) AUTOMOTIVE INDICATOR DETECTION

(71) Applicant: QUALCOMM Incorporated, San Diego, CA (US)

(72) Inventors: Varun Ravi Kumar, San Diego, CA (US); Sweta Priyadarshi, San Diego, CA (US); Senthil Kumar Yogamani, San Diego, CA (US)

(21) Appl. No.: 18/805,911

(22) Filed: Aug. 15, 2024

(51) Int. Cl. G06V 20/58; B60W 30/09; G06V 10/62; G06V 10/74; G06V 10/764; G06V 10/77; G06V 10/80; G06V 10/82

(52) U.S. Cl. CPC G06V 20/584; B60W 30/09; G06V 10/62; G06V 10/761; G06V 10/764; G06V 10/7715; G06V 10/806; G06V 10/82

(57) ABSTRACT

An apparatus is configured to classify indicator lights of surrounding vehicles as either active or inactive. The apparatus may use a Siamese network to determine respective feature vectors from respective images captured by a vehicle at different times. The apparatus may also embed speed and time information in the respective feature vectors based on odometry information associated with the vehicle at a time each respective image was captured, and fuse, using a temporal attention mechanism, features and the speed and time information from the respective feature vectors to produce a fused feature vector. The apparatus may further process the fused feature vector using capsule modules to produce an indicator feature vector, calculate a similarity metric from the indicator feature vector, and process the similarity metric with a classifier to output an indicator classification.

### TECHNICAL FIELD

This disclosure relates to computer vision techniques.

### BACKGROUND

Computer vision applications, including applications in automotives, make use of the detection and analysis of three-dimensional (3D) objects. 3D object detection may include the identification and localization of objects in 3D space using sensors like cameras, LiDAR, and radar. Algorithms process this data to recognize and position objects accurately, enhancing real-time situational awareness.

One example computer vision task for automotive application is indicator detection. Indicator detection refers to the task of identifying whether the turn signals of a vehicle are active or inactive. This detection may be used in various contexts, particularly in autonomous driving systems, where understanding the intentions of surrounding vehicles is useful for safe and efficient navigation.

### SUMMARY

In general, this disclosure describes techniques for indicator (e.g., turn signal, blinker, etc.) detection. In particular, this disclosure describes devices and techniques for determining whether a vehicle is signaling to turn left, signaling to turn or right, or not signaling any turn by detecting the activation status of the indicators of the vehicle.

In accordance with one example of the disclosure, a computing device, such as an advanced driver assistance system (ADAS), may use a Siamese network to extract features from images captured at two or more different times. The computing device may project the features into a birds-eye-view (BEV) representation and embed speed and time features from vehicle into the BEV features. The computing device may then use a temporal attention mechanism to fuse the features. A capsule network may further process the fused features for feature representation learning for indicator detection. The output of the capsule network may then be processed to determine a similarity metric, and the similarity metric may be processed by an indicator state classifier to determine if an indicator of a nearby vehicle is inactive or active. The techniques of this disclosure may improve the efficiency of indicator detection, may be more robust to spatial variability between frames, may take of advantage of temporal consistency, and may generalize well to unseen indicator patterns and environmental conditions.

In one example, this disclosure describes an apparatus configured for indicator classification, the apparatus comprising a memory, and processing circuitry connected to the memory. The processing circuitry configured to generate, using a Siamese network, respective feature vectors from respective images captured by a vehicle at different times, embed speed and time information in the respective feature vectors based on odometry information associated with the vehicle at a time each respective image was captured, fuse, using a temporal attention mechanism, features and the speed and time information from the respective feature vectors to produce a fused feature vector, process the fused feature vector using capsule modules to produce an indicator feature vector, calculate a similarity metric from the indicator feature vector, and process the similarity metric with a classifier to output an indicator classification, wherein the indicator classification includes an active classification or an inactive classification.

In another example, this disclosure describes a method for indicator classification, the method comprising generating, using a Siamese network, respective feature vectors from respective images captured by a vehicle at different times, embedding speed and time information in the respective feature vectors based on odometry information associated with the vehicle at a time each respective image was captured, fusing, using a temporal attention mechanism, features and the speed and time information from the respective feature vectors to produce a fused feature vector, processing the fused feature vector using capsule modules to produce an indicator feature vector, calculating a similarity metric from the indicator feature vector, and processing the similarity metric with a classifier to output an indicator classification, wherein the indicator classification includes an active classification or an inactive classification.

In another example, this disclosure describes a non-transitory computer-readable storage medium storing instructions that, when executed, causes one or more processors to generate, using a Siamese network, respective feature vectors from respective images captured by a vehicle at different times, embed speed and time information in the respective feature vectors based on odometry information associated with the vehicle at a time each respective image was captured, fuse, using a temporal attention mechanism, features and the speed and time information from the respective feature vectors to produce a fused feature vector, process the fused feature vector using capsule modules to produce an indicator feature vector, calculate a similarity metric from the indicator feature vector, and process the similarity metric with a classifier to output an indicator classification, wherein the indicator classification includes an active classification or an inactive classification.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure for indicator classification.

FIG. 2 is a block diagram illustrating an example system that may perform the techniques of this disclosure for indicator classification.

FIG. 3 is a block diagram illustrating one example of the indicator classification unit of FIG. 2 in accordance with the techniques of this disclosure.

FIG. 4 is a flowchart illustrating an example process in accordance with the techniques of this disclosure.

### DETAILED DESCRIPTION

Indicator detection refers to the task of identifying whether a vehicle's indicators are active or inactive. An indicator may also be called a turn signal, blinker, directional signal, signal light, turn indicator, or flasher. The detection of the inactive or active status of an indicator may be important in various contexts, particularly in autonomous driving systems, where understanding the intentions of surrounding vehicles may improve safe and efficient navigation. Here's an overview of the problem and its challenges:

A primary goal of an indicator detection process is to determine whether a vehicle is signaling to turn left, right, or not turning at all by detecting the activation status of the vehicle's indicators. The output of an indicator detection process may be a binary classification indicating whether the vehicle's indicators are active or inactive. Accurately detecting the status of an indicator may be difficult given the following challenges.

Variability in Indicator Appearance: Indicator designs can vary widely across different vehicle models and manufacturers, leading to significant variability in appearance, size, color, and placement. This variability makes it challenging to develop robust detection algorithms that generalize across diverse indicator types.

Illumination and Environmental Conditions: Changes in lighting conditions, such as varying levels of brightness, shadows, glare, or adverse weather conditions, such as rain or fog, can affect the visibility of indicators. Algorithms should be robust to such variations to ensure reliable detection performance in real-world scenarios.

Occlusions and Clutter: Indicators may be partially or fully occluded by other vehicles, objects, or environmental elements, making the indicators harder to detect. Additionally, cluttered scenes with multiple vehicles and objects further complicate the detection task, requiring algorithms to effectively distinguish indicators from background clutter.

Temporal Dynamics: Indicator activations are temporal in nature, with vehicles signaling their intent to turn by activating indicators for a certain duration before making a maneuver. Detecting these temporal dynamics accurately requires algorithms capable of analyzing sequential data and capturing temporal dependencies over time.

One example approach for detecting the statue of indicators uses deep learning techniques, including the use of 3D object detection (3DOD) followed by a long short-term memory (LSTM)-based patch convolutional neural network (CNN) for classification. Initially, this approach focuses on identifying the 3DOD box to localize the indicator, then employs an LSTM-based patch CNN to classify its state, thereby addressing the indicator detection task. Such an approach may exhibit the following drawbacks in some contexts.

Complexity: Combining 3D object detection with LSTM-based patch CNN adds complexity to the model architecture, potentially increasing computational resources and training time.

Dependency on 3DOD Accuracy: The accuracy of indicator state detection relies on the precision of the initial 3D object detection. Any errors or inaccuracies in this step can propagate to the indicator state classification, affecting overall performance.

Limited Generalization: The 3DOD approach may struggle with generalizing to unseen or varying environments or vehicle types. The 3DOD approach might not adapt well to diverse lighting conditions, occlusions, or different types of indicator designs.

Real-time Performance: The computational demands of both 3D object detection and LSTM-based classification may hinder real-time performance, which may be especially important for applications such as autonomous driving where timely responses are may be very important for safe navigation.

Interpretability: The complexity of the model architecture may reduce interpretability, making it challenging to understand how the model arrives at its decisions, which could be important for safety-critical applications.

In view of these drawbacks, this disclosure describes techniques and devices for improving the accuracy and generalization of indicator status detection. For example, a computing device, such as an advanced driver assistance system (ADAS), may use a Siamese network to extract features from images captured at two or more different times. The computing device may project the features into a birds-eye-view (BEV) representation and embed speed and time features from vehicle into the BEV features. The computing device may then use a temporal attention mechanism to fuse the features. A capsule network may further process the fused features for feature representation learning for indicator detection. The output of the capsule network may then be processed to determine a similarity metric, and the similarity metric may be processed by an indicator state classifier to determine if an indicator of a nearby vehicle is inactive or active. The techniques of this disclosure may improve the efficiency of indicator detection, may be more robust to spatial variability between frames, may take of advantage of temporal consistency, and may generalize well to unseen indicator patterns and environmental conditions.

In one example, this disclosure describes an apparatus configured for indicator classification, the apparatus comprising a memory, and processing circuitry connected to the memory. The processing circuitry configured to generate, using a Siamese network, respective feature vectors from respective images captured by a vehicle at different times, embed speed and time information in the respective feature vectors based on odometry information associated with the vehicle at a time each respective image was captured, fuse, using a temporal attention mechanism, features and the speed and time information from the respective feature vectors to produce a fused feature vector, process the fused feature vector using capsule modules to produce an indicator feature vector, calculate a similarity metric from the indicator feature vector, and process the similarity metric with a classifier to output an indicator classification, wherein the indicator classification includes an active classification or an inactive classification.

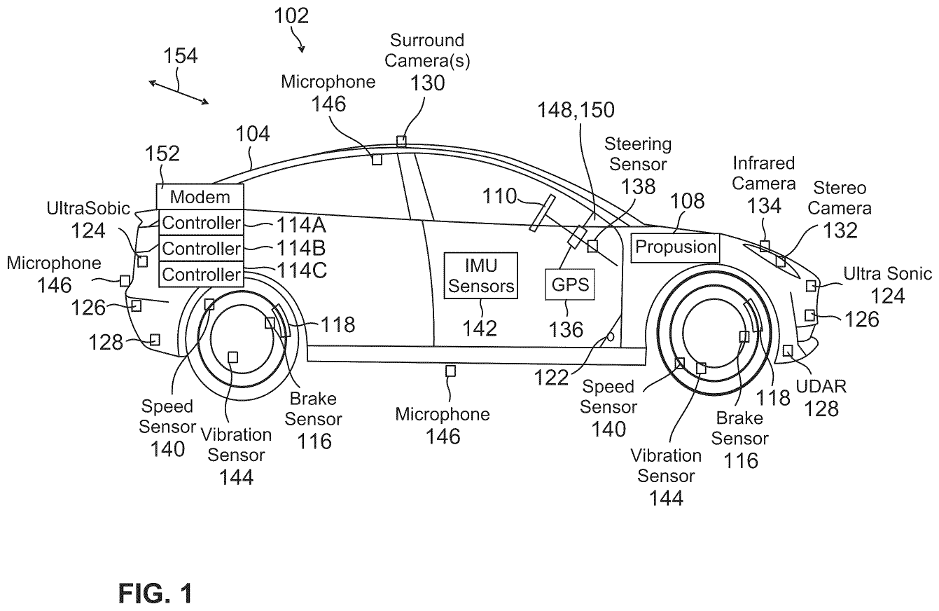

FIG. 1 shows an example vehicle 102. Vehicle 102 in the example shown may comprise a passenger vehicle such as a car or truck that can accommodate a human driver and/or human passengers. In one example, vehicle 102 may comprise an autonomous vehicle, semi-autonomous vehicle and may include an ADAS. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

As discussed above, controller 114 of vehicle 102 may be configured to perform indicator detection. Indicator detection refers to the task of identifying whether a vehicle's indicators are active or inactive. An indicator may also be called a turn signal, blinker, directional signal, signal light, turn indicator, or flasher. The detection of the inactive or active status of an indicator may be important in various contexts, particularly in autonomous driving systems, where understanding the intentions of surrounding vehicles may improve safe and efficient navigation. Here's an overview of the problem and its challenges:

A primary goal of an indicator detection process is to determine whether a vehicle is signaling to turn left, right, or not turning at all by detecting the activation status of the vehicle's indicators. The output of an indicator detection process may be a binary classification indicating whether the vehicle's indicators are active or inactive. Accurately detecting the status of an indicator may be difficult given the following challenges.

Variability in Indicator Appearance: Indicator designs can vary widely across different vehicle models and manufacturers, leading to significant variability in appearance, size, color, and placement. This variability makes it challenging to develop robust detection algorithms that generalize across diverse indicator types.

Illumination and Environmental Conditions: Changes in lighting conditions, such as varying levels of brightness, shadows, glare, or adverse weather conditions, such as rain or fog, can affect the visibility of indicators. Algorithms should be robust to such variations to ensure reliable detection performance in real-world scenarios.

Occlusions and Clutter: Indicators may be partially or fully occluded by other vehicles, objects, or environmental elements, making the indicators harder to detect. Additionally, cluttered scenes with multiple vehicles and objects further complicate the detection task, requiring algorithms to effectively distinguish indicators from background clutter.

Temporal Dynamics: Indicator activations are temporal in nature, with vehicles signaling their intent to turn by activating indicators for a certain duration before making a maneuver. Detecting these temporal dynamics accurately requires algorithms capable of analyzing sequential data and capturing temporal dependencies over time.

One example approach for detecting the statue of indicators uses deep learning techniques, including the use of 3D object detection (3DOD) followed by a long short-term memory (LSTM)-based patch convolutional neural network (CNN) for classification. Initially, this approach focuses on identifying the 3DOD box to localize the indicator, then employs an LSTM-based patch CNN to classify its state, thereby addressing the indicator detection task. Such an approach may exhibit the following drawbacks in some contexts.

Complexity: Combining 3D object detection with LSTM-based patch CNN adds complexity to the model architecture, potentially increasing computational resources and training time.

Dependency on 3DOD Accuracy: The accuracy of indicator state detection relies on the precision of the initial 3D object detection. Any errors or inaccuracies in this step can propagate to the indicator state classification, affecting overall performance.

Limited Generalization: The 3DOD approach may struggle with generalizing to unseen or varying environments or vehicle types. The 3DOD approach might not adapt well to diverse lighting conditions, occlusions, or different types of indicator designs.

Real-time Performance: The computational demands of both 3D object detection and LSTM-based classification may hinder real-time performance, which may be especially important for applications such as autonomous driving where timely responses are may be very important for safe navigation.

Interpretability: The complexity of the model architecture may reduce interpretability, making it challenging to understand how the model arrives at its decisions, which could be important for safety-critical applications.

In view of these drawbacks, this disclosure describes techniques and devices for improving the accuracy and generalization of indicator status detection. For example, controller 114 may be configured to use a Siamese network to extract features from images captured at two or more different times. Controller 114 may project the features into a birds-eye-view (BEV) representation and embed speed and time features from vehicle into the BEV features. Controller 114 may then use a temporal attention mechanism to fuse the features. A capsule network of controller 114 may further process the fused features for feature representation learning for indicator detection. The output of the capsule network may then be processed by controller 114 to determine a similarity metric, and the similarity metric may be processed by an indicator state classifier to determine if an indicator of a nearby vehicle is inactive or active. The techniques of this disclosure may improve the efficiency of indicator detection, may be more robust to spatial variability between frames, may take of advantage of temporal consistency, and may generalize well to unseen indicator patterns and environmental conditions.

As will be discussed in more detail below, controller 114 may be configured to use one or more of the following features to determine the active or inactive state of indicators (e.g., left and/or right indicators) of vehicles within the vicinity of vehicle 102.

Siamese Network for Indicator Detection: Siamese networks are well-suited for tasks involving similarity comparison, and their application to indicator detection allows for effective comparison of feature representations from different BEV frames.

Temporal Attention Mechanism: The incorporation of a temporal attention mechanism enables the model executed by controller 114 to dynamically weigh the contributions of features from different time steps based on their relevance to the current frame and the indicator detection task. The temporal attention mechanism enhances the ability of the model to capture temporal dependencies and improves its performance in detecting indicator activations.

Integration of Vehicle Speed Information: By embedding vehicle speed information into the feature fusion process, the model executed by controller 114 can leverage speed-related cues to enhance indicator detection accuracy. This integration allows the model to adapt its predictions based on the vehicle's speed, which may be important for real-world applications where indicator behavior may vary with speed.

Capsule Network for Feature Representation: The model executed by controller 114 may include capsule networks for feature representation learning in indicator detection. Capsule networks excel at capturing hierarchical relationships and part-whole relationships between features, which can lead to more robust and interpretable representations of indicator activation patterns.

Dynamic Routing by Agreement: The dynamic routing mechanism employed in the capsule network facilitates the learning of part-whole relationships and hierarchical structures present in indicator activation patterns. This adaptive routing mechanism allows the model executed by controller 114 to more effectively associate primary capsule outputs with corresponding indicator feature capsules, enhancing feature representation learning.

Margin Loss Training Objective: The use of a margin loss function during training encourages the capsule network to produce output vectors that more accurately represent the presence or absence of indicator features. This training objective helps improve the ability of the model executed by controller 114 to discriminate between different indicator activation patterns and enhances overall detection performance.

Adaptive Temporal Feature Aggregation: The adaptive fusion mechanism employed in the feature fusion process allows the model executed by controller 114 to dynamically aggregate spatial features, vehicle speed information, and temporal embeddings based on their relevance to the indicator detection task. This adaptive aggregation enhances the model's adaptability to varying input conditions and improves detection accuracy.

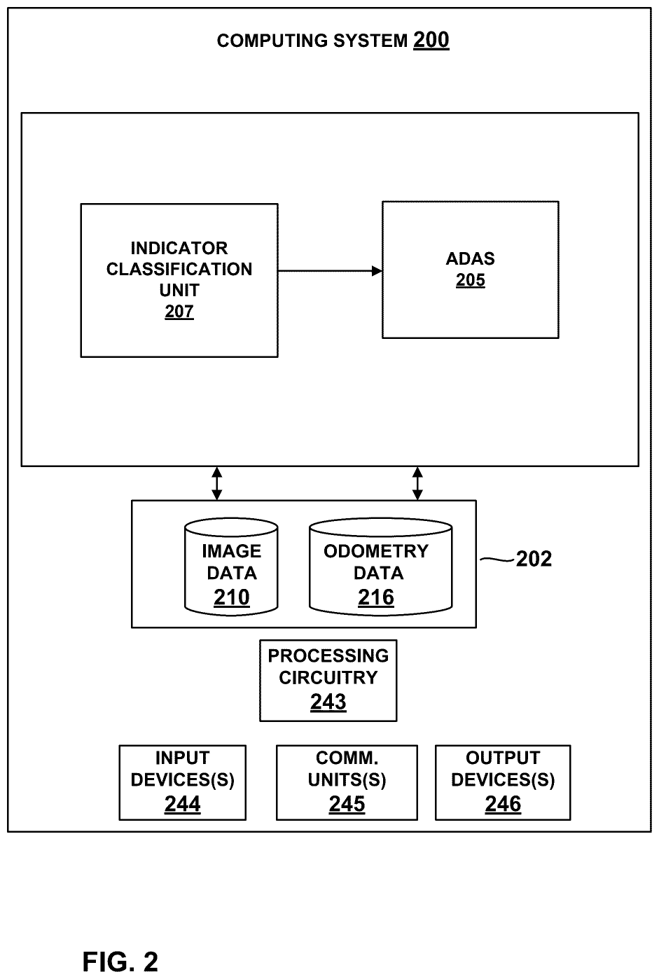

In one example, controller 114 may be configured to generate, using a Siamese network, respective feature vectors from respective images captured by vehicle 102 at different times. Controller 114 may be further configured to embed speed and time information in the respective feature vectors based on odometry information associated with the vehicle at a time each respective image was captured. Controller 114 may be further configured to fuse, using a temporal attention mechanism, features and the speed and time information from the respective feature vectors to produce a fused feature vector. Controller 114 may then process the fused feature vector using capsule modules to produce an indicator feature vector. Controller 114 may then calculate a similarity metric from the indicator feature vector, and process the similarity metric with a classifier to output an indicator classification, wherein the indicator classification includes an active classification or an inactive classification. Additional details on the indicator detection techniques of this disclosure are described below with reference to FIGS. 2-4.

FIG. 2 is a block diagram illustrating an example computing system 200. As shown, computing system 200 comprises processing circuitry 243 and memory 202 for executing indicator classification unit 207 and ADAS 205, which may represent an example instance of any controller 114 described in this disclosure, such as controller 114 of FIG. 1. The example of FIG. 2 shows indicator classification unit 207 and ADAS 205 as being separate. In other examples, indicator classification unit 207 may be a sub-unit of ADAS 205.

Computing system 200 also be implemented as any suitable external computing system accessible by controller 114, such as one or more server computers, workstations, laptops, mainframes, cloud computing systems, High-Performance Computing (HPC) systems (e.g., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure for indicator classification may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., indicator classification unit 207 and/or ADAS 205), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute indicator classification unit 207 and/or ADAS 205 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, ranging sensor (e.g., one or more of radar, sonar, LiDAR, etc.), keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, computing system 200 may be configured to execute indicator classification unit 207. As will be described in more detail below, indicator classification unit 207 may be configured to detect the status (e.g., inactive or active) of an indicator (e.g., left or right indicator) of a vehicle within the vicinity of vehicle 102 using both image data 210 and odometry data 216. Image data 210 may be one or frames of image data captured by any number of cameras 130-134 shown in FIG. 1. Odometry data 216 may include both time speed information of vehicle 102. The time an image was captured and the speed of vehicle 102 at that time may be embedded with features generated from image data 210.

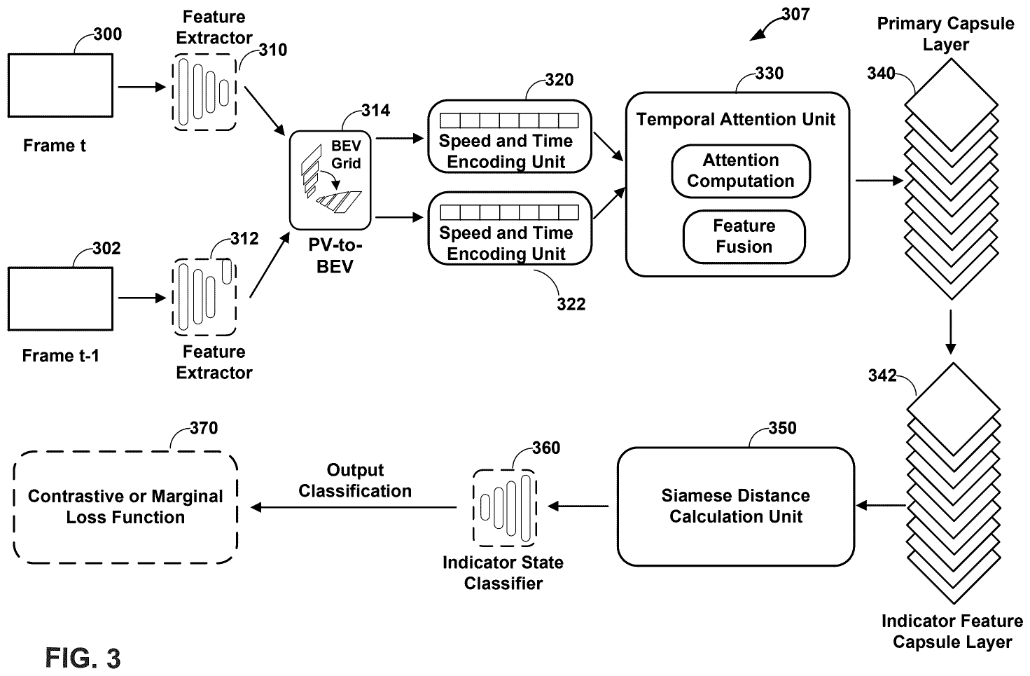

As will be explained in more detail below with reference to FIG. 3, indicator classification unit 207 may be configured to generate, using a Siamese network, respective feature vectors from respective images captured by a vehicle at different times, embed speed and time information in the respective feature vectors based on odometry information associated with the vehicle at a time each respective image was captured, fuse, using a temporal attention mechanism, features and the speed and time information from the respective feature vectors to produce a fused feature vector, process the fused feature vector using capsule modules to produce an indicator feature vector, calculate a similarity metric from the indicator feature vector, and process the similarity metric with a classifier to output an indicator classification, wherein the indicator classification includes an active classification or an inactive classification.

ADAS 205 may be configured to control vehicle 102 at least in part based on the indicator classification. For example, ADAS 205 use the status of the indicators of a nearby vehicle for decisions related to behavior prediction, traffic maneuver planning, human-aware navigation, lane change assistance, collision avoidance, adaptive cruise control, intersection assistance, overtaking and merging, parking assistance, and blind spot monitoring, among other functions.

Behavior Prediction: Understanding the indicator status of surrounding vehicles helps predict their future behavior, such as lane changes, turns, or merges, enabling autonomous vehicles to anticipate and plan safe trajectories accordingly.

Traffic Maneuver Planning: Incorporating information about indicator activations allows vehicles to navigate complex traffic scenarios more effectively, such as yielding to turning vehicles, merging into lanes with active indicators, or adjusting speed based on surrounding traffic intentions.

Lane Change Assistance: If the indicator classifier detects that a nearby vehicle's turn signal is active, ADAS 205 may predict that the vehicle may change lanes. ADAS 205 may then adjust its the speed or position of vehicle 102 to maintain a safe distance and avoid potential collisions.

Collision Avoidance: By monitoring the turn signals of nearby vehicles, ADAS 205 may estimate their movements. For instance, if a vehicle ahead activates its turn signal and starts to slow down, ADAS 205 can preemptively reduce the speed of vehicle 102 to prevent a rear-end collision.

Human-Aware Navigation: Vehicles equipped with indicator detection capabilities in ADAS 205 can interact more effectively with human-driven vehicles by understanding and responding to their signaling behavior, promoting smoother and safer interactions on the road.

Adaptive Cruise Control (ACC): When a nearby vehicle indicates a lane change or a turn, ADAS 205 can adjust the speed of vehicle 102 to accommodate the anticipated maneuver. This better ensures smoother traffic flow and enhances comfort for the driver and passengers.

Intersection Assistance: At intersections, detecting the turn signals of other vehicles allows ADAS 205 to predict their intended paths. This information can be used to optimize the timing of the acceleration or deceleration of vehicle 102 to avoid conflicts and ensure safer passage through the intersection.

Overtaking and Merging: When ADAS 205 detects that a vehicle in an adjacent lane has activated its turn signal to merge into the lane of vehicle 102, ADAS 205 can either slow down or accelerate to create a safe gap, facilitating a smoother merging process.

Parking Assistance: In parking scenarios, understanding the intentions of nearby vehicles through their turn signals helps ADAS 205 manage parking maneuvers more effectively, avoiding potential obstacles and ensuring a safe parking process.

Blind Spot Monitoring: By analyzing the turn signals of vehicles in adjacent lanes, ADAS 205 can provide warnings to the driver if a nearby vehicle intends to enter blind spot of vehicle 102, enhancing situational awareness and reducing the risk of side collisions.

By integrating the output of indicator classification unit 207, ADAS 205 can improve its predictive capabilities and overall effectiveness in managing various driving scenarios, ultimately enhancing road safety and driving comfort.

FIG. 3 is a block diagram illustrating one example of the indicator classification unit of FIG. 2. FIG. 3 shows an indicator classification unit 307 that is one example of indicator classification unit 207 of FIG. 2. The general architecture of indicator classification unit 307 may include one or more of a Siamese network architecture, feature extraction, time and speed embedding, a dynamic time window, temporal feature aggregation, capsule networks, and a similarity metric.

As shown in FIG. 3, indicator classification unit 307 includes a Siamese network architecture design with feature extractor 310 and feature extractor 312. Feature extractor 310 and feature extractor 312 are identical subnetworks (e.g., branches) that share the weights. Feature extractor 310 and feature extractor 312 together may be referred to as a Siamese network. Each of feature extractor 310 and feature extractor 312 takes a frame of image data (e.g., frame t 300 and frame t−1 302, respectively) as input and produces a feature vector. Feature extractor 310 and feature extractor 312 may use convolutional layers to extract features from the input image frames. These layers capture spatial information relevant to indicator detection.

In general, indicator classification unit 307 may generate, using a Siamese network (e.g., feature extractor 310 and feature extractor 312), respective feature vectors from respective images (e.g., frame t 300 and frame t−1 302) captured by a vehicle at different times. The example of FIG. 3 shows a Siamese network with two identical feature extractors that operate on two different images. However, it should be understood that the Siamese network may operate on any number of images (e.g., 3 or more images) captured at any number of different times.

In one example of the disclosure, indicator classification unit 307 may generate, using the Siamese network (e.g., feature extractor 310), a first feature vector from a first frame of image data (e.g., frame t 300) captured by the vehicle at a first time. Indicator classification unit 307 may further generate, using the Siamese network (e.g., feature extractor 311), a second feature vector from a second frame of image data (e.g., frame t−1 302) captured by the vehicle at a second time, wherein the second time is a different time than the first time.

Indicator classification unit 307 may further include a projection unit 314 that takes feature vectors from perspective view (PV) images, such as frames 300 and 302, and projects the feature vectors to a birds-eye-view (BEV) representation projects. That is, projection unit 314 performs a PV-to-BEV projections of the first feature vectors and the second feature vectors to a BEV representation that includes a first BEV feature vector and a second BEV feature vector. In some examples, the BEV projection performed by projection unit 314 may be based on lift, splat, shoot techniques. However, any techniques of BEV projection may be used.

In the example of FIG. 3, indicator classification unit 307 may further include speed and time encoding unit 320 and speed and time encoding unit 322. Speed and time encoding unit 320 operates on the first BEV features produced from frame t 300 and speed and time encoding unit 322 operates on the second BEV features produced from frame t−1 302. In general, speed and time encoding units 320 and 322 are configured to associate each time step or frame with a learnable embedding vector that encodes temporal information. The temporal information may include one or more of the time at which an input frame was captured and/or the speed of the vehicle at the time the input frame was captured.

Speed and time encoding units 320 and 322 may be configured to concatenate or add such temporal information to the input features (e.g., to the first BEV features and the second BEV features, respectively) within the network. By doing so, indicator classification unit 307 can be trained to associate different temporal patterns or dynamics with specific embedding vectors, which can help indicator classification unit 307 better understand and model the temporal dependencies in the data. Time and speed embeddings can be particularly beneficial when dealing with periodic or cyclic patterns in the data, such as traffic patterns or vehicular movements influenced by traffic signals or environmental conditions that vary over time.

Combining attention mechanisms (e.g., temporal attention unit 330) and speed and times embeddings can provide a powerful approach for the lightweight Siamese network to capture both spatial and temporal dependencies in the data. The attention mechanisms can help the model focus on the most relevant spatial regions and time steps, while the time embeddings can encode temporal information and patterns explicitly.

Indicator classification unit 307 may operate according to a dynamic time window that adjusts based on the speed of the vehicle and the complexity of the driving scenario. For example, in high-speed scenarios or dense traffic, a larger time window may be needed to capture relevant indicator state changes. For example, indicator classification unit 307 determine a first time for frame 300 and a second time for frame 302 based on a speed of the vehicle.

Accordingly, indicator classification unit 307 embed speed and time information in the respective feature vectors based on odometry information associated with the vehicle at a time each respective image was captured. For example, speed and time encoding unit 320 is configured to encode first speed and time information in the first BEV feature vector based on first odometry information associated with the vehicle at the first time to produce a first encoded BEV feature vector. Speed and time encoding unit 322 is configured to encode second speed and time information in the second BEV feature vector based on second odometry information associated with the vehicle at the second time, to produce a second encoded BEV feature vector.

Indicator classification unit 307, using temporal attention unit 330, may be configured to perform adaptive temporal feature aggregation. In general, temporal attention unit 330 may be configured to dynamically focus on specific parts of a sequential input over time, enhancing a model's ability to capture important information relevant to the task at hand. A temporal attention mechanism assigns varying levels of importance to different time steps within the input sequence, allowing the model to prioritize certain temporal elements over others. By doing so, the temporal attention mechanism helps in mitigating the effects of long-term dependency issues commonly faced by traditional recurrent neural networks (RNNs).

Temporal attention unit 330 may be configured to perform both attention computation and feature fusion. For example, temporal attention unit 330 may dynamically weigh the contributions of features from different time steps in the past based on their relevance to the current frame and the indicator detection task. For the attention computation, given a sequence of feature vectors X=[x₁, x₂, . . . , x_{T}] where xₜ represents the feature vector extracted from the t-th time step, and a current feature vector c extracted from the current frame, temporal attention unit 330 may compute the weights αₜ as follows:

$${α}_{t} = Softmax ( {w}^{T} f ( {x}_{t} , c ) ) ,$$

where: f(⋅) is a function that combines the feature vectors xₜ and c to compute a relevance score. The variable w is a learnable parameter vector.

In general, indicator classification unit 307 may fuse, using temporal attention unit 330, features and the speed and time information from the respective feature vectors to produce a fused feature vector. For example, temporal attention unit 330 may calculate attention weights based on the first encoded BEV feature vector and the second encoded BEV feature vector, and fuse the first encoded BEV feature vector and the second encoded BEV feature vector based on the attention weights to produce the fused feature vector.

As will be described in more detail below, indicator classification unit 307 may further process the fused feature vector using capsule modules (e.g., primary capsule layer 340 and indicator feature capsule layer 342) to produce an indicator feature vector. Capsule modules in deep learning are a neural network architecture designed to address some limitations of traditional CNNs, particularly their inability to capture spatial hierarchies and relationships between different parts of an image. A capsule is a group of neurons that together represent the instantiation parameters of a specific type of entity, such as an object or part of an object, including its position, orientation, and scale. These capsules work together to ensure that if an entity is present, its corresponding capsule will be highly activated, regardless of its orientation or location in the input image. Capsule networks use a dynamic routing mechanism between layers of capsules to route information, enabling them to preserve the hierarchical pose relationships and thus better understand the spatial structure of the data. This leads to more robust and interpretable models, especially in tasks involving image recognition and reconstruction.

Indicator classification unit 307 process the fused feature vector using primary capsule layer 340 to encode properties of detected features in the fused feature vector, and may process the properties of the detected features using indicator feature capsule layer 342 to produce the indicator feature vector.

Indicator classification unit 307 may also include Siamese distance calculation unit 350 that is configured to compute a similarity metric between the feature vectors produced by the two branches of the Siamese network. Common choices of a similarity metric may include a Euclidean distance, cosine similarity, or contrastive loss. In one example, Siamese distance calculation unit 350 may calculate a similarity metric from the indicator feature vector received from indicator feature capsule layer 342.

Euclidean distance, as a similarity metric, quantifies the direct spatial distance between two points in a Euclidean space. In mathematical terms, the Euclidean distance is the square root of the sum of the squared differences between corresponding coordinates of the points. When used as a similarity metric, a smaller Euclidean distance indicates greater similarity between the points, as they are closer to each other in the multi-dimensional space. Conversely, a larger Euclidean distance suggests greater dissimilarity.

Cosine similarity is a similarity metric that measures the cosine of the angle between two non-zero vectors in an inner product space, which quantifies how similar the vectors are in terms of their direction. The cosine similarity may be calculated as the dot product of the vectors divided by the product of their magnitudes. The cosine similarity ranges from −1 to 1, where a cosine similarity of 1 indicates that the vectors are identical in direction, 0 indicates orthogonality (no similarity), and −1 indicates that the vectors are diametrically opposed.

Contrastive loss is a type of loss function used in machine learning, particularly in tasks involving metric learning and Siamese networks, to measure how well a model can distinguish between similar and dissimilar pairs of data points. The contrastive loss function works by minimizing the distance between similar pairs while maximizing the distance between dissimilar pairs. A contrastive loss function typically involves two components: for similar pairs, the loss increases as the distance between the pairs increases, encouraging the model to bring these pairs closer together; for dissimilar pairs, the loss increases as the distance decreases, encouraging the model to push these pairs further apart. The overall objective of contrastive loss is to create a feature space where similar points are clustered together, and dissimilar points are spread out, improving the model's ability to recognize and differentiate between various classes or categories.

Indicator classification unit 307 may process the similarity metric with indicator state classifier 360 to output an indicator classification. The indicator classification includes an active classification or an inactive classification. As will be discussed in more detail below, indicator state classifier 360 may aggregate a plurality of similarity metrics over two or more time steps to generate an aggregated similarity metric, and determine the indicator classification from the aggregated similarity metric.

A more detail description of FIG. 3 is described blow. First, denote the input image representation at time step t as Xₜ, and the corresponding vehicle speed as vₜ. Indicator classification unit 307 can represent the time-embedded features as follows.

### Spatial Feature Extraction

The image input Xₜ is passed through the shared Siamese encoder network that includes feature extractor 310 and feature extractor 312. Feature extractor 310 and feature extractor 312 may be configured as a CNN or a transformer-based architecture. Feature extractor 310 and feature extractor 312 may produce a spatial feature representation fₜ:

$${f}_{t} = Encoder ( {X}_{t} )$$

### Vehicle Speed Embedding

To incorporate the vehicle speed information, indicator classification unit 307 may include speed and time encoding units 320 and 322 that include a learnable embedding layer that maps the speed value vₜ to a high-dimensional vector representation sₜ, as follows:

$${s}_{t} = SpeedEmbedding ( {v}_{t} )$$

### Temporal Embedding

To capture the temporal dynamics, speed and time encoding units 320 and 322 may include learnable positional encoding or a sinusoidal encoding layers to represent the time step t as a vector eₜ, as follows:

$${e}_{t} = TemporalEncoding ( t )$$

### Feature Fusion

Temporal attention unit 330 may be configured to fuse the spatial features fₜ, vehicle speed embedding sₜ, and temporal embedding eₜ using an adaptive fusion mechanism, such as attention-based fusion or learnable fusion weights. The fused representation hₜ at time step t can be obtained as follows:

$${h}_{t} = AdaptiveFusion ( {f}_{t} , {s}_{t} , {e}_{t} )$$

### Capsule Network

Indicator classification unit 307 may further include a capsule network that includes primary capsule layer 340 and indicator feature capsule layer 342. Capsule networks are designed to model hierarchical relationships and part-whole relationships between features in a more explicit and interpretable manner compared to traditional CNNs. One key idea behind capsule networks is to use groups of neurons, called capsules, to encode the presence and properties of specific features or parts in the input data.

In the context of an indicator detection tasks, indicator classification unit 307 indicator feature capsules, which are capsules specifically designed to encode the presence and properties of indicator features in the input feature space. These capsules can capture intricate spatial and temporal relationships between different parts of the indicator activation patterns, potentially improving the detection accuracy and robustness.

In the example of FIG. 3, indicator classification unit 307 includes a capsule network architecture with two layers: primary capsule layer 340 and indicator feature capsule layer 342. The input to primary capsule layer 340 is the feature map F obtained from a conventional CNN or feature extractor. As shown in FIG. 3, primary capsule layer 340 receives a fused feature map from temporal attention unit 330. Primary capsule layer 340 may include multiple primary capsules, where each capsule is a group of neurons that encode the presence and properties of low-level features or parts in the input feature map F. The output of a primary capsule i of primary capsule layer 340 is a vector representation uᵢ, which encodes the properties of the detected feature or part, such as its position, orientation, and activation pattern.

Indicator feature capsule layer 342 includes multiple indicator feature capsules, where each capsule is configured to encode the presence and properties of a specific indicator feature in the input feature space. The input to a particular indicator feature capsule j is a weighted sum of the predictions (output vectors) from the primary capsules, where the weights cᵢⱼ represent the degree to which a primary capsule i contributes to the indicator feature capsule j. The input vector sⱼ to the indicator feature capsule j is computed as: sⱼ=Σᵢ(cᵢⱼ*uᵢ), where cᵢⱼ is the coupling coefficient that models the relationship between the primary capsule i and the indicator feature capsule j

An indicator feature capsule j of indicator feature capsule layer 342 produces an output vector vⱼ, which encodes the presence and properties of the corresponding indicator feature in the input feature space. The output vector vⱼ is computed using a non-linear squashing function applied to the input vector sⱼ:vⱼ=squash(sⱼ). The squashing function ensures that the output vector vⱼ has a length between 0 and 1, representing the probability or existence of the indicator feature.

### Routing by Agreement

In some examples, primary capsule layer 340 and indicator feature capsule layer 342 may be trained using dynamic routing by agreement. That is, the coupling coefficients cᵢⱼ between the primary capsules and the indicator feature capsules are dynamically updated during the training process using a routing algorithm called “routing by agreement.” The routing algorithm iteratively adjusts the coupling coefficients based on the agreement between the output vectors of the primary capsules and the indicator feature capsules. This routing mechanism allows the capsule network to learn to group and associate the appropriate primary capsule outputs with the corresponding indicator feature capsules, capturing the part-whole relationships and hierarchical structures present in the indicator activation patterns.

### Loss Function and Training

In some examples, the capsule network may be trained using a contrastive or margin loss function 370, which encourages the output vectors vⱼ of indicator feature capsule layer 342 to have a length close to 1 for present indicator features and close to 0 for absent indicator features.

The margin loss function can be defined as:

$$L = {\sum }_{j} ( {T}_{j} * max {( 0 , {m}^{+} - \vert \vert {v}_{j} \vert \vert )}^{2} + λ * ( 1 - {T}_{j} ) * max {( 0 , \vert \vert {v}_{j} \vert \vert - {m}^{-} )}^{2} ) ,$$

where Tⱼ is the ground truth label (1 for present indicator feature, 0 for absent), m⁺ and m⁻ are the margins for present and absent indicator features, respectively, and λ is a down-weighting factor.

By implementing indicator feature capsule layer 342 using capsule networks, indicator classification unit 307 can explicitly capture the hierarchical relationships and part-whole relationships between different components of the indicator activation patterns. The capsules encode the presence and properties of indicator features, while the routing mechanism learns to associate and group the relevant primary capsule outputs with the corresponding indicator feature capsules. This approach has the potential to improve the detection accuracy and robustness by explicitly modeling the intricate spatial and temporal relationships within the indicator activation patterns.

Note that contrastive or margin loss function 370 may only be present in indicator classification unit 307 in a training environment. That is, in some examples, indicator classification unit 307 may not include contrastive or margin loss function 370 for inference time applications.

### Siamese Distance Metric

The fused representation hₜ from the two input branches (representing the pair of vehicles) at time step t are passed through Siamese distance calculation unit 350, which computes the similarity or dissimilarity between the two representations. This can be achieved using a contrastive loss function or a triplet loss. For example, using a contrastive loss function, the distance Dₜ between the two fused representations hₜ¹ and hₜ² can be computed as:

$${D}_{t} = {\vert \vert {h}_{t}^{1} - {h}_{t}^{2} \vert \vert}^{2}$$

The contrastive loss Lₜ at time step t can be defined as:

$${L}_{t} = ( 1 - {y}_{t} ) * {D}_{t}^{2} + {y}_{t} * {max ( 0 , m - {D}_{t} )}^{2} ,$$

where yₜ is a binary label indicating whether the pair of vehicles have active indicators (yₜ=1) or not (yₜ=0), and m is a margin parameter to enforce separation between positive and negative pairs.

### Temporal Aggregation

In some examples, to capture the temporal dependencies across multiple time steps, Siamese distance calculation unit 350 may aggregate the losses or distance metrics over a sequence of T time steps using a temporal aggregation function, such as mean or max pooling:

$$L = TemporalAggregation ( {L}_{{t}_{t = 1}}^{T} )$$

### Classification Output

The aggregated distance metric D output by Siamese distance calculation unit 350 can be used to classify whether the vehicle's indicators are active or inactive using a simple thresholding operation or by adding an additional classification head (e.g., indicator state classifier 360) to the network.

By introducing time embeddings that capture the vehicle speed along with the Siamese network features, the proposed architecture of indicator classification unit 307 can effectively learn the temporal patterns and speed-related cues for accurate indicator detection. The specific implementations of the adaptive fusion mechanism, distance metric, temporal aggregation function, and loss functions can be further explored and optimized based on the available data and computational resources.

The techniques described above may have the following benefits. The techniques of this disclosure may exhibit increased efficiency, as Siamese networks require fewer parameters compared to patch CNNs since Siamese networks process pairs of frames rather than individual patches. This can lead to faster training and inference times, making Siamese networks more efficient for indicator detection tasks.

The techniques of this disclosure may exhibit robustness to spatial variability. Siamese networks inherently learn to focus on spatial changes between frames rather than specific spatial regions, making Siamese networks more robust to variations in the location and size of indicators.

The techniques of this disclosure may leverage temporal consistency. Siamese networks directly address the indicator detection task by considering changes between consecutive frames, explicitly leveraging temporal consistency in the data.

The techniques of this disclosure may exhibit greater generalization to more use cases. Siamese networks can generalize well to unseen indicator patterns and environmental conditions since Siamese networks learn a similarity metric between frames rather than relying on specific spatial patterns.

The Siamese network approach of this disclosure for indicator detection in the BEV space does not rely on detecting 3D object (3DOD) boxes. Instead, the techniques of this disclosure directly compares pairs of consecutive frames to determine changes in indicator states without explicitly localizing the indicators in 3D space. By sidestepping the need for 3D object detection, the Siamese network approach simplifies the detection task and can potentially offer advantages such as reduced complexity, less data dependency, flexibility, and temporal consistency.

Eliminating the need for 3DOD box detection simplifies the overall model architecture, reducing computational complexity and training requirements. Siamese networks can learn directly from pairs of frames without requiring labeled 3DOD box annotations, which may be scarce or challenging to obtain in certain scenarios. Since Siamese networks focus on comparing spatial changes between frames rather than localizing specific objects, Siamese networks can adapt more easily to variations in object appearance, size, and orientation. By considering changes between consecutive frames, Siamese networks inherently capture temporal consistency in indicator activations, which may be important for accurate detection in dynamic environments.

The following is a comparison of features of the present disclosure with other methods.

Previous deep learning-based approaches may have utilized simpler architectures, such as convolutional neural networks (CNNs) for feature extraction and classification. However, the techniques of this disclosure introduces more sophisticated architectures like Siamese networks and capsule networks, which offer advantages in capturing complex spatial and temporal relationships inherent in indicator activation patterns.

Some previous methods may have incorporated basic temporal modeling techniques such as recurrent neural networks (RNNs) or Long Short-Term Memory (LSTM) networks. The techniques of this disclosure may include advanced temporal attention mechanisms and adaptive temporal feature aggregation, allowing for more nuanced modeling of temporal dynamics and improved capture of indicator state changes over time.

Feature fusion in previous methods might have been limited to concatenation or simple aggregation techniques. The techniques of this disclosure include the integration of vehicle speed information alongside spatial features using an adaptive fusion mechanism, enhancing the model's ability to adapt to varying speed-related indicator behaviors.

Previous methods might lack interpretability due to black-box architectures and complex feature representations. The techniques of this disclosure include capsule networks, which offer more interpretable representations by explicitly modeling hierarchical relationships and part-whole structures in indicator activation patterns, enhancing explainability.

Previous deep learning-based methods may have struggled with generalization to diverse scenarios and robustness to variations in indicator activation patterns. The techniques of this disclosure are configured to improve generalization and robustness through the use of advanced architectures, temporal modeling, and adaptive feature integration, allowing for better performance across a range of real-world scenarios.

Previous methods may have utilized standard classification or regression objectives without considering specific characteristics of indicator detection tasks. The techniques of this disclosure employ margin loss training objectives tailored to indicator detection, encouraging the model to produce output vectors that accurately represent the presence or absence of indicator features, thereby improving detection performance.

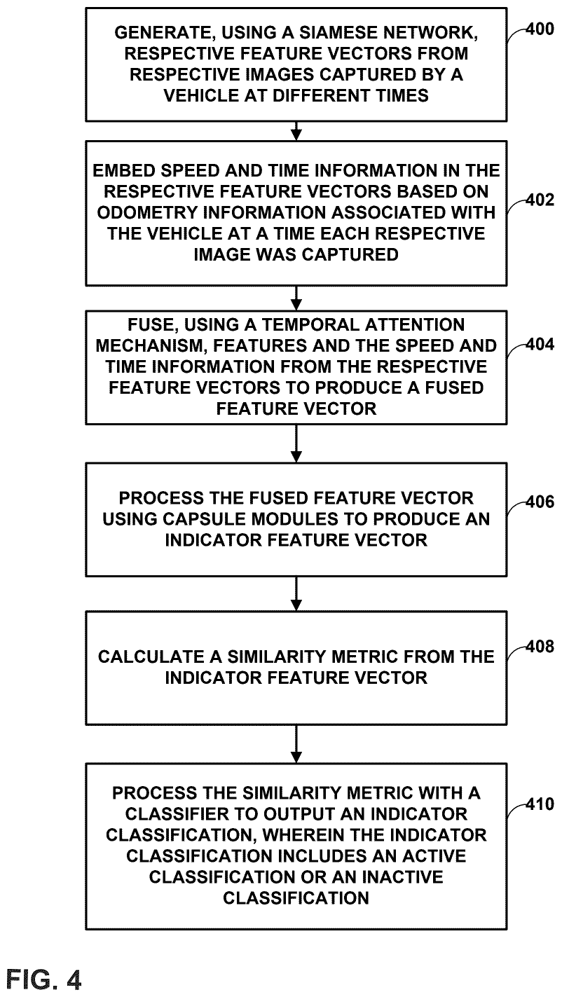

FIG. 4 is a flowchart illustrating an example process in accordance with the techniques of this disclosure. The techniques of FIG. 4 may be performed by one or more components of computing system 200, including indicator classification unit 207 and/or ADAS 205.

Computing system 200 may be configured to generate, using a Siamese network, respective feature vectors from respective images captured by a vehicle at different times (400). In one example, to generate, using the Siamese network, respective feature vectors from respective images captured by the vehicle at different times, computing system 200 is configured to generate, using the Siamese network, a first feature vector from a first frame of image data captured by the vehicle at a first time, generate, using the Siamese network, a second feature vector from a second frame of image data captured by the vehicle at a second time, wherein the second time is a different time than the first time, and project the first feature vectors and the second feature vectors to a birds-eye-view (BEV) representation that includes a first BEV feature vector and a second BEV feature vector.

Computing system 200 may be further configured to embed speed and time information in the respective feature vectors based on odometry information associated with the vehicle at a time each respective image was captured (402). To embed the speed and time information, computing system 200 may encode first speed and time information in the first BEV feature vector based on first odometry information associated with the vehicle at the first time to produce a first encoded BEV feature vector, and encode second speed and time information in the second BEV feature vector based on second odometry information associated with the vehicle at the second time, to produce a second encoded BEV feature vector. Computing system 200 may be further configured to determine a dynamic time window. That is, computing system 200 may determine the first time and the second time based on a speed of the vehicle.

Computing system 200 may be further configured to fuse, using a temporal attention mechanism, features and the speed and time information from the respective feature vectors to produce a fused feature vector (404). In one example, to fuse, using the temporal attention mechanism, the features and the speed and time information from the respective feature vectors to produce the fused feature vector, computing system 200 may be configured to calculate attention weights based on the first encoded BEV feature vector and the second encoded BEV feature vector, and fuse the first encoded BEV feature vector and the second encoded BEV feature vector based on the attention weights to produce the fused feature vector.

Computing system 200 may further process the fused feature vector using capsule modules to produce an indicator feature vector (406). In one example, to process the fused feature vector using the capsule modules to produce the indicator feature vector, computing system 200 is configured to process the fused feature vector using a primary capsule layer to encode properties of detected features in the fused feature vector, and process the properties of the detected features using an indicator feature capsule layer to produce the indicator feature vector. Computing system 200 may also be configured to train the primary capsule layer and indicator feature capsule layer using dynamic routing by agreement.

Computing system 200 may further calculate a similarity metric from the indicator feature vector (408). In one example, the similarity metric is one of a Euclidean distance, a cosine similarity, or a contrastive loss.

Computing system 200 may further process the similarity metric with a classifier to output an indicator classification, wherein the indicator classification includes an active classification or an inactive classification (410). For example, computing system 200 may aggregate a plurality of similarity metrics over two or more time steps to generate an aggregated similarity metric, and determine the indicator classification from the aggregated similarity metric.

The following numbered clauses illustrate one or more aspects of the devices and techniques described in this disclosure.

Clause 1. An apparatus configured for indicator classification, the apparatus comprising: a memory; and processing circuitry connected to the memory, the processing circuitry configured to: generate, using a Siamese network, respective feature vectors from respective images captured by a vehicle at different times; embed speed and time information in the respective feature vectors based on odometry information associated with the vehicle at a time each respective image was captured; fuse, using a temporal attention mechanism, features and the speed and time information from the respective feature vectors to produce a fused feature vector; process the fused feature vector using capsule modules to produce an indicator feature vector; calculate a similarity metric from the indicator feature vector; and process the similarity metric with a classifier to output an indicator classification, wherein the indicator classification includes an active classification or an inactive classification.

Clause 2. The apparatus of Clause 1, wherein to generate, using the Siamese network, respective feature vectors from respective images captured by the vehicle at different times, the processing circuitry is configured to: generate, using the Siamese network, a first feature vector from a first frame of image data captured by the vehicle at a first time; generate, using the Siamese network, a second feature vector from a second frame of image data captured by the vehicle at a second time, wherein the second time is a different time than the first time; and project the first feature vectors and the second feature vectors to a birds-eye-view (BEV) representation that includes a first BEV feature vector and a second BEV feature vector.

Clause 3. The apparatus of Clause 2, wherein to embed the speed and time information, the processing circuitry is configured to: encode first speed and time information in the first BEV feature vector based on first odometry information associated with the vehicle at the first time to produce a first encoded BEV feature vector; and encode second speed and time information in the second BEV feature vector based on second odometry information associated with the vehicle at the second time, to produce a second encoded BEV feature vector.

Clause 4. The apparatus of Clause 3, wherein the processing circuitry is further configured to: determine the first time and the second time based on a speed of the vehicle.

Clause 5. The apparatus of any of Clauses 3-4, wherein to fuse, using the temporal attention mechanism, the features and the speed and time information from the respective feature vectors to produce the fused feature vector, the processing circuitry is configured to: calculate attention weights based on the first encoded BEV feature vector and the second encoded BEV feature vector; and fuse the first encoded BEV feature vector and the second encoded BEV feature vector based on the attention weights to produce the fused feature vector.

Clause 6. The apparatus of any of Clauses 1-5, wherein to process the fused feature vector using the capsule modules to produce the indicator feature vector, the processing circuitry is configured to: process the fused feature vector using a primary capsule layer to encode properties of detected features in the fused feature vector; and process the properties of the detected features using an indicator feature capsule layer to produce the indicator feature vector.

Clause 7. The apparatus of Clause 6, wherein the processing circuitry is further configured to: train the primary capsule layer and indicator feature capsule layer using dynamic routing by agreement.

Clause 8. The apparatus of any of Clauses 1-7, wherein the similarity metric is one of a Euclidean distance, a cosine similarity, or a contrastive loss.

Clause 9. The apparatus of any of Clauses 1-8, wherein to process the similarity metric with the classifier to output the indicator classification, the processing circuitry is further configured to: aggregate a plurality of similarity metrics over two or more time steps to generate an aggregated similarity metric; and determine the indicator classification from the aggregated similarity metric.

Clause 10. The apparatus of any of Clauses 1-9, wherein the processing circuitry is part of an advanced driver assistance system (ADAS), and wherein the ADAS is configured to control the vehicle at least in part based on the indicator classification.

Clause 11. A method for indicator classification, the method comprising: generating, using a Siamese network, respective feature vectors from respective images captured by a vehicle at different times; embedding speed and time information in the respective feature vectors based on odometry information associated with the vehicle at a time each respective image was captured; fusing, using a temporal attention mechanism, features and the speed and time information from the respective feature vectors to produce a fused feature vector; processing the fused feature vector using capsule modules to produce an indicator feature vector; calculating a similarity metric from the indicator feature vector; and processing the similarity metric with a classifier to output an indicator classification, wherein the indicator classification includes an active classification or an inactive classification.

Clause 12. The method of Clause 11, wherein generating, using the Siamese network, respective feature vectors from respective images captured by the vehicle at different times comprises: generating, using the Siamese network, a first feature vector from a first frame of image data captured by the vehicle at a first time; generating, using the Siamese network, a second feature vector from a second frame of image data captured by the vehicle at a second time, wherein the second time is a different time than the first time; and projecting the first feature vectors and the second feature vectors to a birds-eye-view (BEV) representation that includes a first BEV feature vector and a second BEV feature vector.

Clause 13. The method of Clause 12, wherein embedding the speed and time information comprises: encoding first speed and time information in the first BEV feature vector based on first odometry information associated with the vehicle at the first time to produce a first encoded BEV feature vector; and encoding second speed and time information in the second BEV feature vector based on second odometry information associated with the vehicle at the second time, to produce a second encoded BEV feature vector.

Clause 14. The method of Clause 13, further comprising: determining the first time and the second time based on a speed of the vehicle.

Clause 15. The method of any of Clauses 13-14, wherein fusing, using the temporal attention mechanism, the features and the speed and time information from the respective feature vectors to produce the fused feature vector comprises: calculating attention weights based on the first encoded BEV feature vector and the second encoded BEV feature vector; and fusing the first encoded BEV feature vector and the second encoded BEV feature vector based on the attention weights to produce the fused feature vector.

Clause 16. The method of any of Clauses 11-15, wherein processing the fused feature vector using the capsule modules to produce the indicator feature vector comprises: processing the fused feature vector using a primary capsule layer to encode properties of detected features in the fused feature vector; and processing the properties of the detected features using an indicator feature capsule layer to produce the indicator feature vector.

Clause 17. The method of Clause 16, further comprising: training the primary capsule layer and indicator feature capsule layer using dynamic routing by agreement.

Clause 18. The method of any of Clauses 11-17, wherein the similarity metric is one of a Euclidean distance, a cosine similarity, or a contrastive loss.

Clause 19. The method of any of Clauses 11-18, wherein processing the similarity metric with the classifier to output the indicator classification comprises: aggregating a plurality of similarity metrics over two or more time steps to generate an aggregated similarity metric; and determining the indicator classification from the aggregated similarity metric.

Clause 20. A non-transitory computer-readable storage medium storing instructions that, when executed, causes one or more processors to: generate, using a Siamese network, respective feature vectors from respective images captured by a vehicle at different times; embed speed and time information in the respective feature vectors based on odometry information associated with the vehicle at a time each respective image was captured; fuse, using a temporal attention mechanism, features and the speed and time information from the respective feature vectors to produce a fused feature vector; process the fused feature vector using capsule modules to produce an indicator feature vector; calculate a similarity metric from the indicator feature vector; and process the similarity metric with a classifier to output an indicator classification, wherein the indicator classification includes an active classification or an inactive classification.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured for indicator classification, the apparatus comprising:
a memory; and
processing circuitry connected to the memory, the processing circuitry configured to:
generate, using a Siamese network, respective feature vectors from respective images captured by a vehicle at different times;
embed speed and time information in the respective feature vectors based on odometry information associated with the vehicle at a time each respective image was captured;
fuse, using a temporal attention mechanism, features and the speed and time information from the respective feature vectors to produce a fused feature vector;
process the fused feature vector using capsule modules to produce an indicator feature vector;
calculate a similarity metric from the indicator feature vector; and
process the similarity metric with a classifier to output an indicator classification, wherein the indicator classification includes an active classification or an inactive classification.

2. The apparatus of claim 1, wherein to generate, using the Siamese network, respective feature vectors from respective images captured by the vehicle at different times, the processing circuitry is configured to:
generate, using the Siamese network, a first feature vector from a first frame of image data captured by the vehicle at a first time;
generate, using the Siamese network, a second feature vector from a second frame of image data captured by the vehicle at a second time, wherein the second time is a different time than the first time; and
project the first feature vectors and the second feature vectors to a birds-eye-view (BEV) representation that includes a first BEV feature vector and a second BEV feature vector.

3. The apparatus of claim 2, wherein to embed the speed and time information, the processing circuitry is configured to:
encode first speed and time information in the first BEV feature vector based on first odometry information associated with the vehicle at the first time to produce a first encoded BEV feature vector; and
encode second speed and time information in the second BEV feature vector based on second odometry information associated with the vehicle at the second time, to produce a second encoded BEV feature vector.

4. The apparatus of claim 3, wherein the processing circuitry is further configured to:
determine the first time and the second time based on a speed of the vehicle.

5. The apparatus of claim 3, wherein to fuse, using the temporal attention mechanism, the features and the speed and time information from the respective feature vectors to produce the fused feature vector, the processing circuitry is configured to:
calculate attention weights based on the first encoded BEV feature vector and the second encoded BEV feature vector; and
fuse the first encoded BEV feature vector and the second encoded BEV feature vector based on the attention weights to produce the fused feature vector.

6. The apparatus of claim 1, wherein to process the fused feature vector using the capsule modules to produce the indicator feature vector, the processing circuitry is configured to:
process the fused feature vector using a primary capsule layer to encode properties of detected features in the fused feature vector; and
process the properties of the detected features using an indicator feature capsule layer to produce the indicator feature vector.

7. The apparatus of claim 6, wherein the processing circuitry is further configured to:
train the primary capsule layer and indicator feature capsule layer using dynamic routing by agreement.

8. The apparatus of claim 1, wherein the similarity metric is one of a Euclidean distance, a cosine similarity, or a contrastive loss.

9. The apparatus of claim 1, wherein to process the similarity metric with the classifier to output the indicator classification, the processing circuitry is further configured to:
aggregate a plurality of similarity metrics over two or more time steps to generate an aggregated similarity metric; and
determine the indicator classification from the aggregated similarity metric.

10. The apparatus of claim 1, wherein the processing circuitry is part of an advanced driver assistance system (ADAS), and wherein the ADAS is configured to control the vehicle at least in part based on the indicator classification.

11. A method for indicator classification, the method comprising:
generating, using a Siamese network, respective feature vectors from respective images captured by a vehicle at different times;
embedding speed and time information in the respective feature vectors based on odometry information associated with the vehicle at a time each respective image was captured;
fusing, using a temporal attention mechanism, features and the speed and time information from the respective feature vectors to produce a fused feature vector;
processing the fused feature vector using capsule modules to produce an indicator feature vector;
calculating a similarity metric from the indicator feature vector; and
processing the similarity metric with a classifier to output an indicator classification, wherein the indicator classification includes an active classification or an inactive classification.

12. The method of claim 11, wherein generating, using the Siamese network, respective feature vectors from respective images captured by the vehicle at different times comprises:
generating, using the Siamese network, a first feature vector from a first frame of image data captured by the vehicle at a first time;
generating, using the Siamese network, a second feature vector from a second frame of image data captured by the vehicle at a second time, wherein the second time is a different time than the first time; and
projecting the first feature vectors and the second feature vectors to a birds-eye-view (BEV) representation that includes a first BEV feature vector and a second BEV feature vector.

13. The method of claim 12, wherein embedding the speed and time information comprises:
encoding first speed and time information in the first BEV feature vector based on first odometry information associated with the vehicle at the first time to produce a first encoded BEV feature vector; and
encoding second speed and time information in the second BEV feature vector based on second odometry information associated with the vehicle at the second time, to produce a second encoded BEV feature vector.

14. The method of claim 13, further comprising:
determining the first time and the second time based on a speed of the vehicle.

15. The method of claim 13, wherein fusing, using the temporal attention mechanism, the features and the speed and time information from the respective feature vectors to produce the fused feature vector comprises:
calculating attention weights based on the first encoded BEV feature vector and the second encoded BEV feature vector; and
fusing the first encoded BEV feature vector and the second encoded BEV feature vector based on the attention weights to produce the fused feature vector.

16. The method of claim 11, wherein processing the fused feature vector using the capsule modules to produce the indicator feature vector comprises:
processing the fused feature vector using a primary capsule layer to encode properties of detected features in the fused feature vector; and
processing the properties of the detected features using an indicator feature capsule layer to produce the indicator feature vector.

17. The method of claim 16, further comprising:
training the primary capsule layer and indicator feature capsule layer using dynamic routing by agreement.

18. The method of claim 11, wherein the similarity metric is one of a Euclidean distance, a cosine similarity, or a contrastive loss.

19. The method of claim 11, wherein processing the similarity metric with the classifier to output the indicator classification comprises:
aggregating a plurality of similarity metrics over two or more time steps to generate an aggregated similarity metric; and
determining the indicator classification from the aggregated similarity metric.

20. A non-transitory computer-readable storage medium storing instructions that, when executed, causes one or more processors to:
generate, using a Siamese network, respective feature vectors from respective images captured by a vehicle at different times;
embed speed and time information in the respective feature vectors based on odometry information associated with the vehicle at a time each respective image was captured;
fuse, using a temporal attention mechanism, features and the speed and time information from the respective feature vectors to produce a fused feature vector;
process the fused feature vector using capsule modules to produce an indicator feature vector;
calculate a similarity metric from the indicator feature vector; and
process the similarity metric with a classifier to output an indicator classification, wherein the indicator classification includes an active classification or an inactive classification.
